(19) United States
(12) Patent Application Publication
(10) Pub. No.: US 2015/0058930 A1
(43) Pub. Date: Feb. 26, 2015

(54) METHOD AND APPARATUS FOR ENABLING AUTHORISED USERS TO ACCESS COMPUTER RESOURCES

(71) Applicant: ROYAL HOLLOWAY AND BEDFORD NEW COLLEGE, Surrey (GB)

(72) Inventors: Christopher John Mitchell, Codford (GB); Haitham Al-Sinani, Egham (GB)

(21) Appl. No.: 14/345,194

(22) PCT Filed: Sep. 12, 2012
(86) PCT No.: PCT/GB2012/052257

§ 371 Date: Oct. 3, 2014

(30) Foreign Application Priority Data
Sep. 14, 2011 (GB) 1115866.4

(51) Int. Cl. H04L 29/06; G06F 3/0482; G06F 3/0481

(52) U.S. Cl. CPC H04L 63/10; H04L 63/08; G06F 3/04817; G06F 3/0482
USPC 726/3

(57) ABSTRACT

An authentication system is disclosed for use in authenticating an entity to a relying party, to enable the entity to access a protected resource provided by the relying party via a web page, comprising an authentication component installable in a web browser used by the entity to access the web page, the authentication component comprising (a) a page scanner component which is operable when the entity accesses the web page to scan the web page (and/or to ask the entity) to identify a plurality of authentication systems supported by the web page; and (b) an activator component which is operable when the entity accesses the web page to install an identity system selector component in the web page which is operable to interact with the entity to enable the entity to select which of the plurality of authentication systems to use.

### TECHNICAL FIELD

The present invention relates to a method and apparatus for allowing individuals to access computer resources that they are authorised to access or use, whilst denying access to those not so authorised.

### BACKGROUND

The problem of allowing individuals, devices or software systems to be able to access only those systems and services which are appropriate for them is important in both social and commercial contexts. There has been considerable research on the topic covering many aspects, including how to establish the identity of an individual, device or software system and how to reliably authenticate that identity to another individual, device or software system in various contexts.

One important such context is when an individual, the end user, is attempting to access devices or services while using a client computer or device. A mechanism must be provided by which the user can be securely authenticated as having appropriate permission to be given such access. Often the user will be using a web browser of some kind to attempt access.

The present applicant has appreciated the desirability of enabling the end user to use one or more existing identity and authentication software services to achieve authentication, without the provider of the information and services, the service provider, needing to make specific modifications to their hardware or software systems to enable this.

A principal technical benefit of this would be to allow the end user to provide evidence of their entitlement to access information or services where previously this would not have been possible without expensive modifications to their own systems by third party service providers.

The requirement for service providers to modify their own systems in order to allow end users to authenticate using existing identity and authentication software services has proven a significant impediment to the use of these services. It is desirable to find a solution to this.

### SUMMARY

We will describe the invention in the context of an architecture for a client-based identity management tool, which we will call IDSpace, that operates in conjunction with a client web browser.

Alternative architectures could also incorporate the present invention and allow its benefits to be realised. IDSpace is used as an illustrative context for the invention.

A tool conforming to the architecture provides a user-intuitive and consistent means of managing a wide range of types of digital identities and credentials for user web activities.

The IDSpace architecture can support all existing identity management protocols, and can be used to replace all existing identity management client software. Examples include the CardSpace client, [Vittorio Bertocci, Garrett Serack, and Caleb Baker. Understanding Windows CardSpace: An Introduction to the Concepts and Challenges of Digital Identities. Addison-Wesley, Reading, Mass., 2008], the Higgins client [http://www.eclipse.org/higgins/], Liberty-enabled client software [Scott Cantor and John Kemp (editors). Liberty ID-FF protocols and schema specification. Liberty Alliance Project, 2005. http://www.projectliberty.org/resource_center/specifications/liberty_alliance_id_ff_1_2_specif ications], and client-based password managers.

It is important to observe that IDSpace is not an identity management system (IdMS), at least in the sense in which the term is normally used (where the user is constrained to a single communications protocol between the involved parties). Instead it is an architecture for a client system which enables the use of a multiplicity of identity management protocols, with maximal transparency to the user (and avoiding the need to install multiple identity management clients). The IDSpace architecture is designed so that conformant tools are able to work with all existing Internet service providers (also known as relying parties) and Internet identity providers without any changes to their current operation. That is, the system will be transparent to all third parties.

An implementation of the IDSpace architecture is, nevertheless, an authentication system. It provides all the functions of an identity management system whilst allowing considerable freedom in the way in which the various parties interact.

The IDSpace architecture is designed to be platform-independent, and we anticipate the development of a prototype implementation capable of being deployed on Windows, Unix, Mac, and smart phone-based platforms with minimal changes. Key parts of the system can be instantiated as browser add-ons, e.g. written in C++ and/or JavaScript, thereby maximising portability.

As with any identity management tool, the primary purpose of an IDSpace implementation is to enable an end user to access a protected resource. Once installed on a user device, an IDSpace tool will execute whenever a user wishes to access a protected service using a web browser. It allows the user to select a particular identity management system from amongst those supported by the service provider. It also allows the user to choose which set of credentials is to be used with this service provider, where the network interactions with the service provider and the identity provider (where relevant) will conform to the chosen identity management system.

An IDSpace system interacts with the user via a component known as the Card Selector. This provides a visual representation of user credential sets in the form of ‘virtual cards’, referred to throughout as credential cards (cCards). The operation of this component is motivated by the identity selector (IdS) incorporated into Microsoft's® CardSpace, which also uses virtual cards (in this case known as InfoCards, an abbreviation for Information Card, which is also occasionally abbreviated to iCard). Another system using a very similar card-based user interface is known as Higgins, which also uses the term InfoCards.

A virtual card can represent any one of a wide range of types of user credential, including:
ready-to-use credential tokens, including ‘password manager’ tokens containing a username/password pair, (referred to throughout as local cCards); and
a pointer to a remote, credential-issuing party (referred to throughout as remote cCards).

Whilst the notion of IDSpace is similar to CardSpace and Higgins in terms of its user interface, it is also important to note certain fundamental differences. Both CardSpace and Higgins support just a single set of protocols for web interactions between the user platform and third party systems. If future versions of these systems support additional protocols, then this will require corresponding modifications to service providers and identity providers.

IDSpace, by contrast, is designed to work with almost any conceivable identity management protocol suite, and its adoption does not require any changes to third party systems (notably identity providers and service providers).

IDSpace is made up of a set of self-contained components interacting with each other in a predefined way, thus enabling modular implementation. Such an architectural design enables new identity protocols to be supported in a simple way by adding new software modules to an existing implementation.

### BRIEF DESCRIPTION OF THE DRAWINGS

FIG. 1 shows how the context in which IDSpace architecture functions and how it relates to the main other architectural components including identify and service providers.

FIG. 2 shows the relationships between the main components of IDSpace, including the primary information flows.

FIGS. 3A to 3C contain a flowchart showing the end user's possible interactions with IDSpace when IDSpace identifies a request for authorisation from a service provider web page.

FIG. 4 is a schematic illustration of a hardware in which a method embodying the present invention can be implemented.

### HIGH-LEVEL ARCHITECTURE

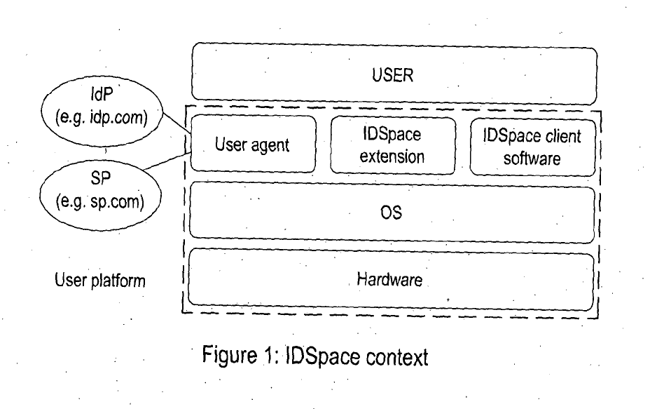

IDSpace provides a user-intuitive and consistent means for managing digital identities and credentials for user web activities. The context of use is shown in FIG. 1.

The parties involved, as shown in the figure, include the following.

1 The user interacts with a user platform or hardware platform (e.g. a PC or mobile device) in order to access services provided across the Internet. This user platform is equipped with an operating system (OS) on which applications execute.

2 The identity provider (IdP) provides identity services to the user. This typically involves issuing a user-specific identity token for consumption by a service provider. This token will provide the service provider with assurance regarding certain attributes of the user, e.g. the user identity. The IdP is located either remotely or locally on the user platform; in the latter case the IdP is referred to as a local identity provider (LIP). Examples of possible IdPs include Facebook® and Google®.

3 The service provider (SP) provides services which the user wishes to access. In order to allow the user to access a protected resource, the SP will wish to be provided with verifiable statements regarding certain attributes of the user. This is typically achieved by supplying the SP with a user-specific credential or identity token issued by a local or remote IdP. (In some existing identity management systems the SP is known as a relying party (RP)). Examples of possible SPs include YouTube®, Amazon®, Facebook® and Google® (i.e. some parties may act as both IdPs and SPs).

4 The user agent (UA) is a software component employed by a user to manage interactions between the user/user platform and remote entities (IdPs and SPs). This will typically be instantiated as a web browser, such as Internet Explorer or Firefox; indeed, for the sake of simplicity, in some subsequent discussions we refer to a web browser rather than a UA. The user agent processes protocol messages on behalf of the user, and prompts the user to make decisions, provide secrets, etc.

5 The IDSpace Client software, implementing part of the IDSpace architecture, is an application that interacts with the user via a graphical user interface (GUI). This GUI allows the user to select a particular credential set (represented as a cCard) for use in a specific transaction with an SP. The application also interacts with the web browser, and, where necessary, with remote entities.

6 The IDSpace extension (sometimes also referred to as the IDSpace browser extension), implementing part of the IDSpace architecture, supplements the functionality of the UA. This component is made up of a set of modules each performing a certain task, e.g. scanning a webpage for a username-password login form. The IDSpace extension exchanges data with the client software via the browser, and, where necessary, interacts with the user.

IDSpace Components

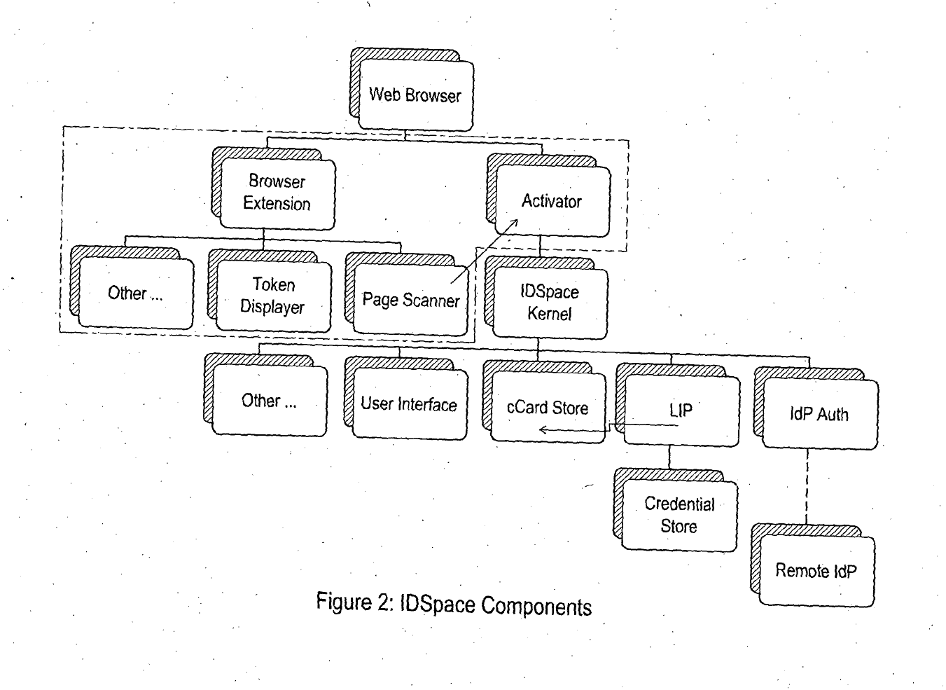

FIG. 2 shows the relationships between the main components of IDSpace, including the primary information flows. The dotted line shows the limits of the browser extension. The rest of the components, apart from the ‘web browser’ and ‘remote IdP’ boxes, represent the other part of the IDSpace architecture, i.e. the client software. Note that the boxes displaying ‘Other . . . ’ refer to other IDSpace components, which, although covered in the text, are not shown in the figure.

Note that the Activator could either be considered as an independent component or as a browser extension module. This is because, in certain identity systems e.g. CardSpace, the SP webpage must implement certain X/HTML tags to enable this component to perform its task (see below). However, it is also possible for a browser extension to add such tags.

The two primary elements of the IDSpace architecture, i.e. the IDSpace client software and the IDSpace extension (as introduced above), are now discussed in greater detail.

The client software, a stand-alone application, is made up of the following components.

cCards. A cCard is a (relatively non-sensitive) XML document corresponding to a set of user credentials (or, more generally, to a set of user private information). A cCard indicates the types of personal information in the set, and also the type (or types) of identity management system with which the cCard can be used. However, it does not contain the personal information itself. cCards can be local, in which case they are generated by the LIP, or remote, in which case they are generated by a remote IdP. (In CardSpace, the LIP is known as the SIP (self-issued identity provider)).

cCard Store. This is a protected local store for cCards. The nature of the protection provided for stored cCards will depend on the implementation environment. For example, protection could involve the use of cryptography, physical protection and/or logical protection (as provided by the OS).

Credential Store. This is a protected local store for sensitive data, such as personal information, certificates, user passwords, etc., associated with local cCards. It is used by the LIP. Note that, in practice, the Credential Store and the cCard Store could be combined. As for the cCard store, the nature of the protection provided will be implementation-dependent and could involve the use of cryptography, physical protection and/or logical protection.

Settings Store. This is a local store for (relatively) non-sensitive data such as system state, system/user settings, user preferences, etc.

IDSpace Kernel. This is the central component of IDSpace. It runs locally on the user platform, handling communications with and between other components of IDSpace. In particular, it performs the following functions.
It receives and processes the security policy provided by the Activator.
It retrieves the cCards from the cCard Store, and checks which of them meet the requirements of the service provider's security policy.
It invokes the IDSpace User Interface in a private desktop window, and displays the cCards that meet the service provider's policy requirements.
If a remote cCard is chosen, it retrieves the security policy of the relevant remote IdP by initiating a connection with it.
It communicates with the user-selected IdP, i.e. either a remote IdP or the LIP, to obtain an identity token, where necessary using the IdP Auth component.

User Interface. This component, which incorporates the IDSpace Card Selector, is the main means by which an end user interacts with the IDSpace client software. Its tasks include the following.
It displays the identity of the SP website to the user, including indicating whether the website has been visited previously. If the website is being visited for the first time then it allows the user to either continue or terminate.
It displays the available cCards (it might display all the cards and highlight those that meet the SP site policy, or it might only display those meeting the policy). Note that the cCards are displayed in the ‘Card Selector’, a part of the User Interface.
It allows the user to review the contents of a cCard.
It allows the user to generate and modify ‘local’ cCards (as opposed to ‘remote’ cCards generated by remote IdPs)—in doing so it provides an interface to some of the functions of the LIP.
It allows the user to import a cCard provided by a remote IdP.
It allows a user to be asked for explicit consent before providing potentially sensitive information to an SP.
It allows the user to set preferences for future operation of the system. These preferences are stored in the Settings Store.

LIP. This provides the functionality of an IdP, but is resident on the user platform. Like any IdP, the LIP can generate identity tokens. These tokens can be retrieved by the IDSpace Kernel. The LIP stores user-attribute values and other sensitive user data in the Credential Store.

IdP Auth. This authenticates the user to a remote IdP, if a remote cCard is selected. It uses the User Interface to prompt the user to enter the required credentials, e.g. username-password, and then submits them to the corresponding IdP. By doing so it enables a consistent and simple user interface to be provided to the user, even when a range of different identity protocols are being used. It also supports IdP-specific protocol interactions, e.g. to create requests for specific types of token.

Networker. This initiates a direct online connection between the client software and a remote server (i.e. not involving the browser).

The IDSpace extension, typically implemented as a browser add-on, includes the following modules.

Page Scanner. This browser extension module scans the SP website login-page in order to discover the identity system(s) supported by the SP website. It passes the results of the scan to the Identity System Selector.

Activator. This is a (logical) bridge between the client browser and the IDSpace Kernel. Its tasks include the following.
It informs the user that the IDSpace system can be used.
It provides the means to enable the user to activate the Card Selector.

Identity System Selector. This browser extension module enables the user to select which identity management system to be used from amongst those supported by the SP website. The precise operation of this component will depend on the implementation of the IDSpace architecture.

If more than one identity system is available, the Identity System Se-lector could ask the user to either choose an identity system immediately or defer the selection until the point at which a cCard is selected (using the IDSpace Card Selector). It might also provide a means to store the user answer (in the Settings Store) for future authentication attempts. It passes the user response to the Data Transporter.

Data Transporter. This browser extension module provides the means to exchange data between components of the IDSpace architecture, including the following.
It is responsible for the transfer of metadata regarding the SP page (e.g. the discovered and selected identity system(s), the identity of the SP, the SP website policy requirements, etc.), to the IDSpace Kernel. For example, if the user indicates that IDSpace is to be used, it passes the security policy of the SP website to the IDSpace Kernel.
It transfers data from the IDSpace Kernel to the browser. For example, if IDSpace obtains or generates an identity token during the authentication process, it gives the token to browser which dispatches it to the SP website.

Token Displayer. This browser extension module displays an indication of the contents of an IdP-generated identity token to the user. This helps the user to decide whether or not to allow the token to be passed to the SP. This function can only be provided if the token is not:
encrypted in such a way that only the SP can read it (e.g. using an SP's public key); and
transmitted via a background (direct) IdP-SP channel, i.e. the token must pass via the client platform.

Supporting Functionality

We next discuss a number of functions that an IDSpace-conformant system provides. For many of these functions we outline multiple approaches to implementation.

IDSpace must be able to determine which identity systems are supported by the user-visited SP website. This can be accomplished in a number of different ways, including the following.

IDSpace could scan the visited page for HTML/XHTML tags that are associated with specific identity management systems. For example, the string: ‘application/x-informationCard’ indicates that the site supports CardSpace; and ‘openid url’ and/or ‘openid identifier’ indicates website support for OpenID. The benefits of such an approach include complete transparency, albeit at the cost of performance (because IDSpace must scan every web page).

Alternatively, IDSpace could ask the user which identity management systems the page currently supports. The benefits of such an approach include accuracy and higher performance, at the cost of transparency and user convenience.

Alternatively, IDSpace could employ a hybrid approach based on a combination of the above two options, e.g. so that if the first option fails then it resorts to the second option.

Identity System Selection

Having learnt which identity management system(s) the visited SP website supports, IDSpace must allow the user to select which identity management system to use for the current transaction. Such a process could take place before or after the invocation of the IDSpace Card Selector. We next consider the two options in greater detail.

Prior to selector invocation, IDSpace could allow the user to choose an identity management system in a variety of different ways, including the following.
IDSpace could embed a descriptive icon (logo, image, link or button) in the web page for each available system, and require the user to select one (e.g. by clicking the selected icon). Whilst this approach may be intuitive and transparent, it could damage the appearance of the page, particularly if there are many logos to embed.
Alternatively, IDSpace could ask the user which system they wish to use by embedding forms in the page or by triggering pop-up boxes. The benefits of such an approach would include accuracy and higher performance, at the cost of minor user convenience.
Alternatively, IDSpace could add an identity management system selection option to the in-page context menu (i.e. the menu that appears as a result of right-clicking). Once such an option is selected, a list of identity management systems would be displayed, allowing the user to select one. Whilst this might be transparent, it might not be so intuitive to end users.
Alternatively, IDSpace could extend the browser frame, e.g. by adding a browser icon, bar or menu. This could have the effect that, once the added icon (or bar or menu) is selected, it would allow the user to select one of the systems currently supported by the SP. Whilst this may be transparent, modifying the browser frame could be somewhat intrusive to the end user.
Both the browser frame and the browser-displayed web page could be extended. Browser extensions could, for example, create lightweight buttons, menu extensions, and in-process browser helper objects. The browser frame could be extended using band objects, and the web page content could be enhanced with, for example, ActiveX Controls or similar technologies [for example see Matthew Crowley. Pro Internet Explorer 8 & 9 Development: Developing Powerful Applications For The Next Generation Of IE. Apress, New York, 2010].

Alternatively, after selector invocation, the IDSpace Card Selector could display the currently supported identity management systems, allowing the user to select one. This choice could be combined with a display of the available cCards (if any) associated with each of the systems. In the latter case, the selector window could be partitioned so that each section displays an identity management system along with a previously used cCard for that system; a clickable option could be used to request the display of other available cCards. This approach would be transparent, convenient and would avoid making changes to web browsers or web pages. However, it would require more processing, and hence could adversely affect client platform performance.

Card Selector Invocation

In response to a user action, IDSpace must be able to invoke the IDSpace card selector. This involves embedding IDSpace support in the SP web page using a browser extension (see above).

IDSpace must help the user discover an IdP from which the user can obtain a suitable identity token. This process varies considerably depending on the identity management system. Specific approaches must therefore be devised for each supported system. The primary goal of the architecture is to allow this to take place in a way that is both as user-transparent as possible and gives a view of the process to the user that is consistent across identity systems.

The format of cCards, which we assume are XML documents, must be sufficiently flexible and self-contained in order to allow cCard storage in a variety of locations, and to allow portability. We assume that cCards will be protected while stored (where, as stated previously, the nature of this protection will be implementation-dependent). We suppose that cCards are XML documents because such an approach has been used in existing identity management systems. However, other formats could be used, e.g. JSON (httpliwww.json.orgi).

cCards could be stored on various media, including:
local file systems, which would give good performance and allow fast retrieval;
remote web servers (the cloud'), which would give a roaming capability;
portable user devices such as mobile phones or smart cards, which would also provide a roaming capability.

Each cCard will contain an identifier indicating the identity system with which it can be used (in principle a cCard could have many such identifiers).

As noted above, we suppose here that cCards are encoded using XML. A single XML schema could be devised encompassing all supported identity management systems. This would have the advantage that the identity sys-tem identifier (discussed immediately above) could form part of the encoding of a cCard.

Alternatively, a separate XML schema could be devised for each identity system, although this would have the disadvantage that each cCard would itself need to be stored with identifier(s) indicating the identity system(s) with which it can be used.

Again as noted above, other methods of encoding could also be used, such as JSON.

The content of a cCard will vary depending on the identity system with which it is intended to be used. However, the types of content listed below are likely to be contained in almost all cCards.

1 A list of supported attribute types, e.g. age, password, first name, last name, the values of which are known by the IdP, and for which the IdP will be prepared to generate an identity token. The actual claim values are not stored by the Card Selector; they are either stored by the remote IdP or by the LIP. The LIP will store the values in the protected Credential Store. Protection could, for example, involve implementing the Credential Store on a separate device such as a smart card, or using a TPM to provide encrypted storage.

2 A list of supported token type(s), indicating which type(s) of identity token (e.g. SAML, username-password) the IdP(s) associated with the card IdP can issue.

3 IdP location, including the (physical) URI/URL address(es) of the (remote or local) IdP(s).

4 IdP authentication method(s), specifying the method(s) employed by the IdP to authenticate the user.

5 Display information, e.g. an image and or a name for the cCard.

Where possible, the IDSpace processes should be isolated from other processes to maximise the security and privacy of data handled by IDSpace. For example, on a Windows platform the IDSpace Card Selector could be invoked in a private desktop session.

Authentication Methods

The IDSpace architecture allows the user to be authenticated to an IdP using a wide range of different authentication methods. The ease with which additional methods can be supported depends on precisely how user authentication to a remote IdP is supported by IDSpace. We consider three main possibilities.

IDSpace could control all communications between the user and the remote IdP. That is, all requests for authenticating information by the IdP could be made to the user by IDSpace (specifically by the IdP Auth component, as described in section 2 and FIG. 2), and the supplied information could then be forwarded by IDSpace to the remote IdP. Adding a new authentication method would require adding functionality to the implementation of IDSpace executing on the user platform. (This is the approach adopted by CardSpace, currently deployed versions of which support four authentication methods). New user authentication techniques could be added in a modular fashion, as and when they are required. Whilst this would clearly add to the cost of deploying and maintaining an IDSpace implementation, for a widely deployed system this does not seem such an unreasonable approach (given that the number of authentication methods seems unlikely to grow very rapidly).

Such an approach would have the advantage of user transparency and would enable the provision of a consistent user interface for the authentication process.

Alternatively, IDSpace could cause the task of user authentication to be performed at the IdP rather than via the IDSpace User Interface (i.e. using the IdP Auth component). That is, whenever a remote IdP requires user authentication (e.g. prior to issuing an identity token), IDSpace would redirect the user agent (web browser) to the IdP, allowing the IdP to directly authenticate the user using a method of the IdP's choice. Although such a simple approach would minimise the maintenance cost for IDSpace, the user would lose the consistent experience provided by the IDSpace User Interface.

Alternatively, IDSpace could employ a hybrid approach. The default would be the first approach outlined above. IDSpace could support a set of widely-adopted (possibly standardised) authentication methods; new methods could be added as and when it is deemed appropriate. However, if an IdP wishes to use a technique not supported by IDSpace, then IDSpace could redirect the user agent (web browser) to the IdP for ‘direct’ authentication.

IDSpace Operation

Previous sections have described the functions of components of the IDSpace architecture. We now describe how a system implemented according to the architecture would operate.

Prior to use of IDSpace, the following preparatory steps must be performed.
The IDSpace components, including the browser extension and the client software, must be installed on the user platform.
The user must install cCards in the cCard Store on the user platform. As noted above, these cCards can be created by either a local or a remote IdP. We briefly consider the two cases.
Local cCards are created using the LIP. Once it has created a cCard, the LIP will insert it in the cCard Store, and the corresponding user data will be added to the Credential Store. Note that a user could also choose to create a local cCard during use of IDSpace.
Remote cCards are created by remote IdPs. Typically the creation of such a cCard will occur via an ‘out of band’ process, i.e. a process completely independent of the operation of IDSpace, perhaps involving the user completing a registration process using the IdP website. The resulting cCard will be provided to the user, and the user can then arrange for it to be imported into IDSpace using the IDSpace User Interface.
For ease of identification, the user can personalise a cCard, e.g. by giving the card a meaningful name, and/or uploading an image representing the card to be displayed by the User Interface.

We now describe the operation of IDSpace. It is important to note that some parts of the operation of IDSpace will vary depending on the specific identity management system in use. The operation of IDSpace in the case of two widely discussed identity management systems is discussed in the next section.

The following protocol will take place. These steps are described from the perspective of the IDSpace system itself.

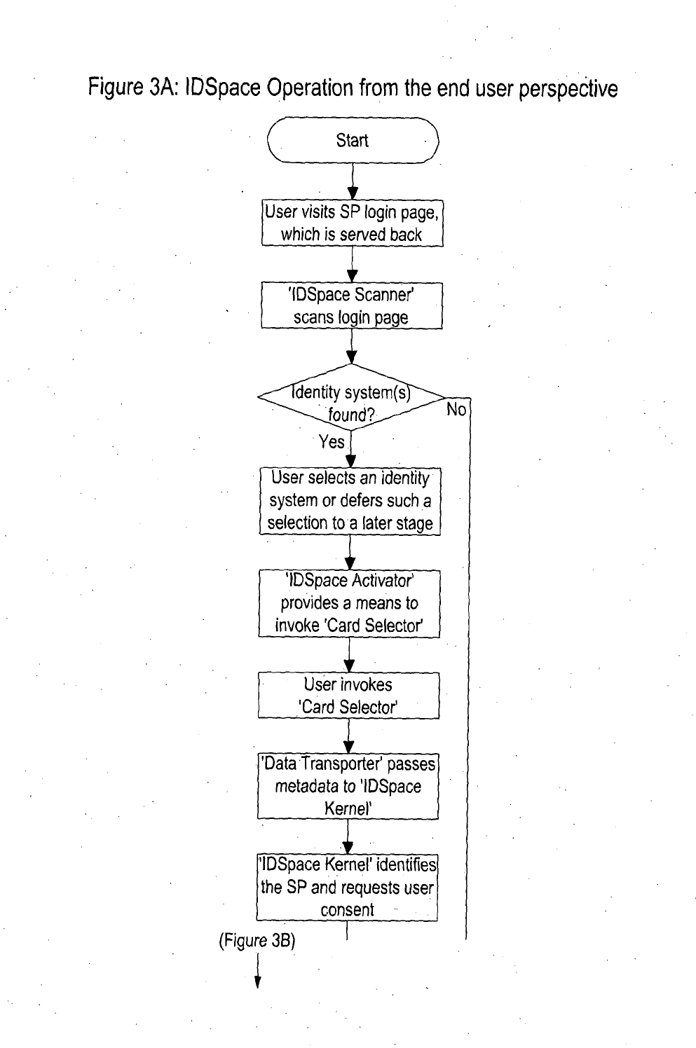

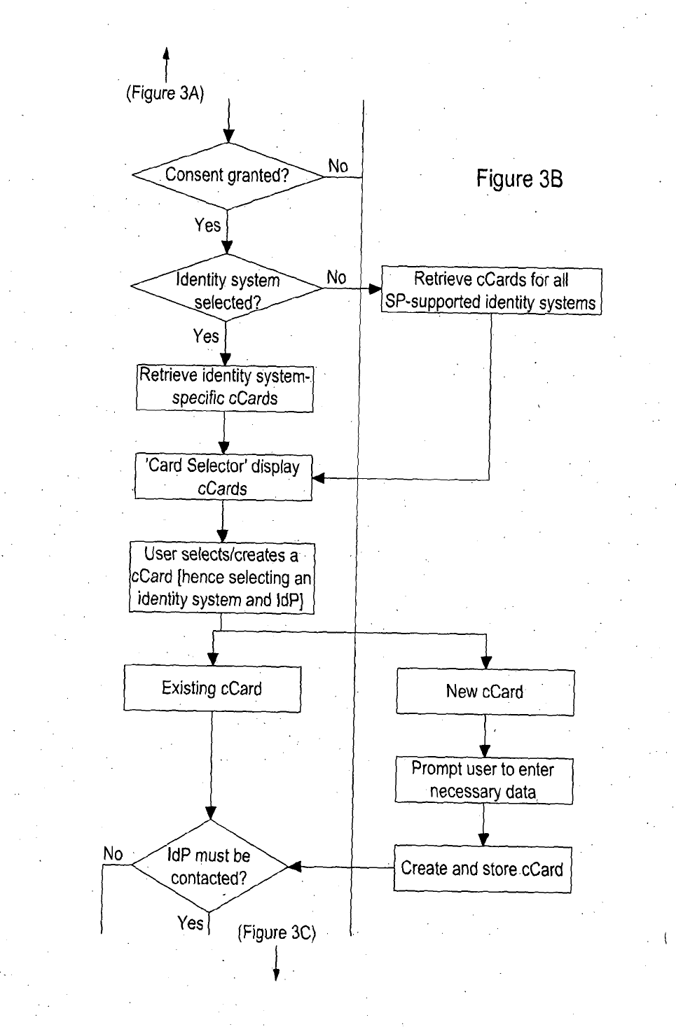

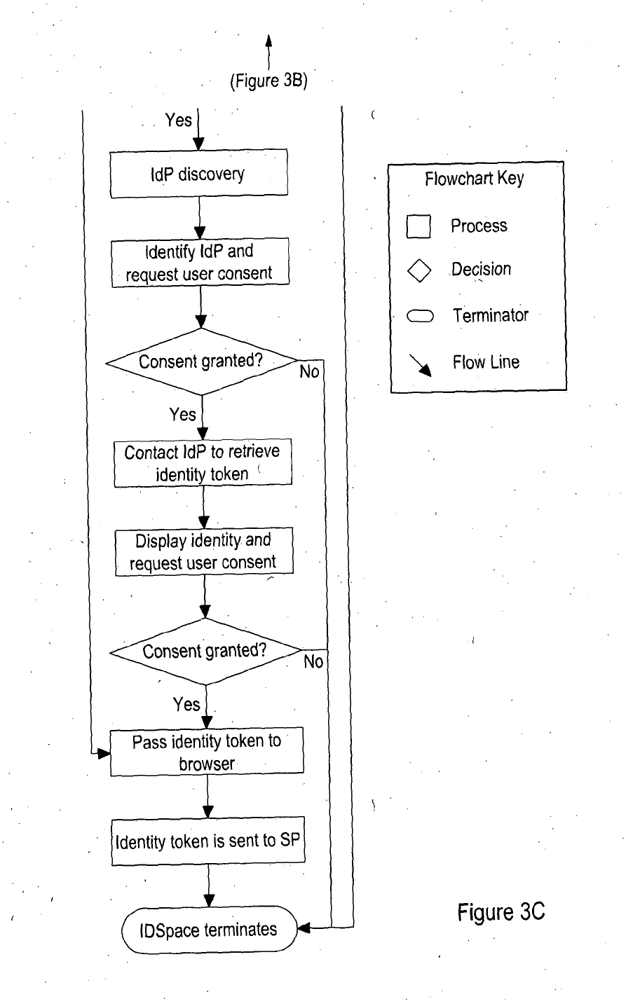

The resulting process as seen from the perspective of the user is shown in the flowchart in FIG. 3.

1. UA->SP: HTTP/S GET Request. A user employs the User Agent to navigate to an SP login page.

2. SP->UA: HTTP/S Response. A login page is returned to the User Agent.

3. IDSpace browser Extension->UA: Page Processing. Certain IDSpace browser extension modules (as described below) perform the following processes on the login page provided by the SP.
(a) Page Scanner→UA: Page Scanning. The Page Scanner module scans the login page to discover which identity system(s) are sup-ported by the SP (from amongst those supported by IDSpace). It passes the identifiers of the supported systems to the Identity System Selector or, if no such systems are supported, it terminates operation of IDSpace.
(b) Identity System Selector→UA. The Identity System Selector module uses the results passed to it by the Page Scanner. If more than one identity system is discovered, then (depending on the implementation) the Extension module may ask the user to choose one of them. Alternatively, the decision could be deferred and made using the IDSpace Card Selector. The advantages and disadvantages of the two approaches are discussed in section 3.2. A further alternative approach would involve the user deciding at which stage to make a choice.
   The module might also offer to store any choices made by the user (in the Settings Store) for managing future authentication attempts. The module finally reports all the results to the Data Transporter module (see below).
(c) Activator⇄UA: Card Selector Activation. The Activator module provides a means for the user to activate the IDSpace Card Selector. How this is achieved is implementation specific (options are discussed in sections 3.2 and 3.3). This involves embedding IDSpace-enabling tags and an IDSpace security policy in the login page. The embedded policy is subsequently used by the IDSpace User Interface to help it select and highlight specific cCards.

4. User→UA: Card Selector Invocation. The user performs an action which invokes the IDSpace Card Selector. The precise way in which this occurs is implementation specific (options are discussed in the section above on identity system selection).

5. Data Transporter→IDSpace Kernel: Passing Metadata. The Data Transporter module passes the necessary metadata (e.g. the identified and/or selected identity system(s), the SP identity, the SP policy requirements, etc.) to the IDSpace Kernel.

6. IDSpace Kernel⇄Card Selector: SP Identity. The IDSpace Kernel examines the SP identity (as received from the Data Transporter module in the previous step), including noting whether or not the SP uses HTTPS and whether or not the user has visited this particular SP before. The IDSpace Kernel uses the IDSpace Card Selector to:

(a) identify the SP to the user; and

(b) ask the user whether to continue or terminate the protocol.

Depending on the user answer, IDSpace either continues or terminates the protocol. To assist in user decision-making, the Card Selector could indicate key security-relevant features of the SP to the user. For example, it could indicate whether or not the SP:
uses HTTPS;
possesses an extended evaluation certificate;
has been visited before; and/or
requires a large number of, or particularly sensitive, user attributes.

The Card Selector could also offer the user a recommendation as to whether or not to continue, based on user policy settings and the SP's security properties.

7. IDSpace Kernel⇄IDSpace Components. The IDSpace Kernel evaluates the received metadata in order to learn which actions to take. If the user has already chosen an identity system, the following processes take place.
(a) IDSpace Kernel⇄cCard Store: cCards Retrieval. The IDSpace Kernel retrieves the appropriate cCards (possibly none) by comparing the received metadata with the available cards. Note that the retrieved cards are specific to the user-selected identity system.
(b) IDSpace Kernel→Selector: Displaying cCards. The IDSpace Kernel passes the retrieved cCards to the Card Selector so that they can be displayed to the user. cCards previously used with this SP (if any) could be displayed more prominently than the others.

If the user has not yet chosen an identity system, then the following processes take place.
(a) IDSpace Kernel⇄cCard Store: cCard Retrieval. The IDSpace Kernel retrieves the appropriate cCard(s) by comparing the received metadata with the available cards. Note that cards will be retrieved for all the SP-supported identity systems.
(b) IDSpace Kernel→Card Selector: Displaying SP-supported Identity Systems+cCards. The Kernel passes the SP-supported identity systems, along with the matching cCards (if any), to the Card Selector to be displayed to the user. The Card Selector displays the list of supported identity systems, together with the available cCards, indicating which cards have been used previously with this SP (it could also indicate which identity systems have been previously used with this SP). Depending on the implementation and the number of systems and cards to be displayed, the Card Selector might only display the cards previously used. In such a case it would need to indicate that other cards are also available, and would need to provide a means to retrieve them.

In both cases, the Card Selector should also allow the user to create a new local cCard (if the relevant identity system supports such cards).

8. User→Card Selector: Selecting/Creating cCards. The user selects (or creates) a cCard.

9. Card Selector→IDSpace Kernel: User Action Results. The Card Selector reports the results of the user actions back to the IDSpace Kernel.

10. IDSpace Kernel⇄IDSpace Components. The IDSpace Kernel evaluates the results received from the Card Selector, and takes the appropriate steps.

If the user has chosen to select an existing cCard, then the following processes take place.
(a) The IDSpace Kernel determines whether an IdP (local or remote) needs to be contacted. If not, control is passed to step 13. If so, the protocol continues.
(b) The IDSpace Kernel determines the IdP (local or remote) that must be contacted in order to enable the user to obtain the identity token required by the SP. This also includes determining the nature of the information regarding the user (e.g. login credentials) that must be supplied to this IdP.
(c) IDSpace Kernel Card Selector: Displaying IdP identity. If this IdP has not previously been used, or if it does not use HTTPS, the IDSpace Kernel uses the Card Selector to obtain user consent before sending the IdP any information. This step is designed to mitigate the risks of phishing attacks. In such a case the Card Selector reports the user response back to the Kernel.
(d) If user consent has been obtained, the Kernel now passes a token request to the IdP. The token request may have been received from the SP, or, if necessary, the IDSpace Kernel creates the request.

If the user has chosen to create a local cCard, the following processes take place.
(a) IDSpace Kernel⇄Selector GUI. The Kernel invokes a special Card Selector window to allow the user to enter the necessary data. This would typically include allowing the user to personalise the image, e.g. uploading a card image, entering a card name, etc. Such steps would enable the card to be readily recognisable.
(b) IDSpace Kernel⇄Card Creation Module (in the LIP): Card Creation. The Kernel instructs the Card Creation module to create an XML-based cCard using the user-inserted data. The Card Creation module returns the newly-created card to the Kernel.
(c) IDSpace Kernel⇄cCard Storage Module: Card Storage. The Kernel sends the cCard to the Card Storage module for permanent storage; the Card Storage module reports back to the Kernel whether or not the operation has been successful.
(d) IDSpace Kernel⇄Card Selector. The Kernel treats the newly-created cCard as a user-selected cCard and step 10a repeats.

11. IDSpace Kernel IdP. One of the following processes take place, exactly which one depending on whether the selected IdP is local or remote.

If a remote IdP is selected, and if such information is required by the IdP (and is not already stored by IDSpace) then the IDSpace Kernel prompts the user to enter the relevant IdP credentials using a special credential screen. If this fails, e.g. if the Kernel does not support the IdP authentication method, or if the user-selected identity system dictates that the User Agent must be redirected to the IdP, then the Kernel redirects the User Agent (web browser) to the remote IdP along with an authentication request. In the latter case the IdP can authenticate the user directly using an authentication method of its choice.

If user authentication is successful, the IdP issues an identity token.

If a local IdP is selected, then the Kernel constructs a token request and sends it to the LIP. The LIP responds with an appropriate identity token.

12. Token Displayer Module User. If an identity system other than CardSpace is in use, then the Token Displayer module intercepts, analyses, and displays information about the identity token before releasing it to the SP, and seeks user consent for release. If consent is denied, then the protocol is terminated. Note that this assumes that the token is not end-to-end encrypted to the SP, e.g. using the SP public key.

If CardSpace is in use, then the CardSpace IdP will send back a display token along with the real token, which the Kernel can instruct the Card Selector to display to the user, prior to obtaining user consent.

13. IDSpace Kernel→UA→SP: Passing Identity Token. The identity token is passed to the User Agent, which forwards it to the SP.

14. SP→User: Grant/Deny Access. The SP validates the token, and, if satisfied, grants access to the user.

Mapping Specific Protocol Architectures onto IDSpace

Identity management systems can be classified according to how the SP communicates via the client with the IdP. There are two main ways in which this can be achieved, namely by using an HTTP redirect or involving an active client.

1 Redirect-based Systems. In such a scheme, the User Agent is redirected by an SP to an IdP (and vice versa). In such a case the User Agent is essentially passive, and does not need to be aware of the identity system in use. One major disadvantage is that a malicious SP can redirect the User Agent to a malicious IdP impersonating an expected IdP (e.g. to fraudulently obtain user credentials). Example systems of this type include OpenID, Liberty (browser-post profile), Shibboleth, and Facebook Connect.

2 Active client-based Systems. In schemes of this type, the User Agent must incorporate an ‘active client’, which acts as an intermediary between SPs and IdPs, and which must be aware of the identity management system in use. Typically all communication between SP and IdP occurs via this active client, and there is no need for direct SP-IdP communication. Depending on the details of the system in use, the active client can prompt the user to select a digital identity, choose an IdP, review (and perhaps modify) an identity token created by the IdP, and approve a transaction. Phishing attacks are mitigated since an SP cannot redirect the User Agent to an IdP of its choosing. The active client can also provide a consistent user experience, and its existence helps to give the user a greater degree of control. Examples include CardSpace and Liberty (when using a Liberty-enabled client (LEC)).

We now describe how two examples of specific identity management systems can be mapped onto the IDSpace architecture. We have chosen to consider OpenID and Liberty (using a LEC) as widely discussed examples of the above two models. We also briefly describe CardSpace support.

Note that the descriptions below are intended to serve as examples only, and are not intended to suggest that this is the only way in which the systems concerned could be supported using IDSpace.

IDSpace and OpenID

Either prior to, or during, use of IDSpace, the user must create an OpenID-specific cCard. This cCard must contain one required field, and may also contain one optional field, as follows.

1 The single required field must contain the user's OpenID; this field could, for example, be named ‘OpenID Identifier’.

2 The optional field contains the identifier of the user's OpenID IdP; this field could, for example, be named ‘OpenID Provider’.

The cCard is in XML format and contains a unique, OpenID-specific identifier. The cCard is stored in the secure cCard store, possibly in an OpenID-specific location (e.g. to allow faster look-up/retrieval).

We now describe a possible way in which IDSpace could support OpenID. IDSpace could achieve the same objective using other versions of the protocol described below.

Steps 3b, 4-9, 10a-d (second series), 13 and 14 of the IDSpace-OpenID-specific protocol are the same as steps 3b, 4-9, 10a-d (second series), 13 and 14, respectively, of the generic IDSpace protocol given above, and hence are not described here. Whenever prompted to select/create/import a cCard, it is assumed that the user will select/create/import an OpenID-specific cCard.

1. UA→SP: HTTP/S GET Request. A user navigates to an OpenID-enabled SP.

2. SP→UA: HTTP/S Response. A login page is returned containing an OpenID form.

3. IDSpace Browser Extension→UA: Page Processing. The browser ex-tension performs the following processes on the login page provided by the SP.

(a) Page Scanner Module→UA: Page Scanning. The Page Scanner module searches the login page for an OpenID login form; such a form can be identified in an HTML form by searching for an input field named ‘openid url’ and/or ‘openid identifier’. (The Page Scanner module also scans the page for triggers for any other identity management systems currently supported by the IDSpace system.) Finally, the module passes the search results to the Identity System Selection module.

(c) Activator⇄UA: Selector Activation. The Activator module performs the following processes.
i. It embeds IDSpace-enabling tags in the SP-provided login page, including a security policy statement in the format required by the IDSpace system. This policy statement must request OpenID-specific cCards.
ii. It adds a special function to the SP-provided login page to intercept the identity token that will later be returned by the IDSpace Kernel.
iii. It employs certain (implementation-dependent) means to en-able the user to activate the IDSpace Card Selector (see sections 3.2 and 3.3); e.g. it might cause a special icon to appear above the submit button with the property that clicking this icon invokes the selector.

10. IDSpace Kernel IDSpace Components. The IDSpace Kernel evaluates the results (as provided by the Card Selector) in order to take appropriate actions. If the user has chosen to select an existing OpenID-specific cCard, then the following steps are performed.

(a) The IDSpace Kernel retrieves the XML of the cCard and passes it to the UA.

(b) The Browser Extension parses the received XML, retrieving the value of the user's OpenID and (if present) the OpenID IdP.

(c) The Browser Extension temporarily stores the OpenID IdP value.

(d) The Browser Extension adds the user's OpenID identifier to the OpenID form, and submits the form back to the SP.

(e) The SP initiates an OpenID authentication request.

(f) The Browser Extension intercepts the SP-initiated OpenID authentication request, and compares the value of the OpenID IdP in this request with the OpenID IdP value it stored in step 10c. If they match, the process continues (with redirection of the user agent to the IdP). If not, the Browser Extension could either terminate or warn the user of a possible phishing threat and ask whether or not to continue.

(g) From this point on, OpenID operates as it would do in the absence of IDSpace, except for the final check in step 12 (see also the discussion below). In particular the user experience is OpenID-specific, and the user will see the OpenID IdP's authentication page.

11. OpenID IdP User. If necessary (Authentication may be unnecessary if a valid authentication session between the IdP and the user already exists), the OpenID IdP authenticates the user. If successful, the OpenID IdP requests permission from the user to send the OpenID assertion token to the SP.

12. Token Displayer User. When the OpenID IdP attempts to redirect the user agent back to the SP, the Token Displayer module intercepts, analyses, and displays the OpenID identity token to the user before releasing it to the SP. If user consent is obtained, then the protocol continues; otherwise it terminates. Note that this is possible since the OpenID token provided by the IdP is not encrypted.

The above example describes only a partial integration of OpenID with IDSpace. It might be possible to replace the direct authentication of the user by the OpenID IdP with a process mediated by IDSpace (specifically using the IdP Auth module). This could enhance the user experience by making the user authentication process consistent across different identity management systems.

IDSpace and Liberty (LEC)

Either prior to, or during, use of IDSpace, the user must create a Liberty-specific cCard. This cCard must contain one required field, and may also contain one or more optional fields, as follows.

1. The single required field must contain the identifier of the user's Liberty IdP; this field could, for example, be named ‘Liberty Provider’.

2. The optional field(s), could contain other alternative ‘backup’ Liberty IdPs; each such field could, for example, be named ‘Liberty Backup Provider X’, where X is a positive integer.

The cCard is in XML format and contains a unique, LEC-specific identifier. The cCard is stored in the secure cCard store, possibly in a Liberty (LEC)-specific location (e.g. to allow faster look-up/retrieval).

The IdP Auth module is part of the client software. When supporting Liberty (LEC profile) its functionality includes the ability to handle token requests in Liberty format (received from Liberty SPs and sent to Liberty IdPs) and also the means to parse and process token messages received from a Liberty IdP. It makes use of the Networker module to communicate with the IdP and SP.

We now describe a possible way in which IDSpace could act as a Liberty client. Of course IDSpace could achieve the same objective using other versions of the protocol described below.

Steps 3(b,c), 4-9, 10a-d (second series), 13 and 14 of the IDSpace-LEC-specific protocol are the same as steps 3(b,c), 4-9, 10a-d (second series), 13 and 14, respectively, of the generic IDSpace protocol given in section 4.2, and hence are not described here. Whenever prompted to select/create/import a cCard, it is assumed that the user will select/create/import a Liberty-specific cCard.

1 UA→SP: HTTP/S GET Request. A user navigates to a LEC-enabled SP.

2 SP→UA: HTTP/S Response. A login page is returned containing an option (e.g. a button, link, or image) to use Liberty (we use Liberty here and below to mean Liberty using the LEC profile).

3 IDSpace Browser Extension→UA: Page Processing. The Browser Extension performs the following process on the login page provided by the SP.
Page Scanner Module→UA: Page Scanning. The Page Scanner module searches the login page for a distinguishing feature that indicates support for Liberty. (The Page Scanner module also scans the page for triggers for any other identity management systems currently supported by the IDSpace system.) Finally, the module passes the search results to the Identity System Selection module.

10. IDSpace Kernel IDSpace Components. The IDSpace Kernel evaluates the search results (as provided by the Card Selector) in order to take appropriate actions. If the user has chosen to select an existing Liberty-specific cCard, then the following steps are performed.
a) The IDSpace Kernel retrieves the XML of the cCard, and passes it to the IdP Auth module.
b) The IdP Auth module parses the received XML, retrieving the values of the LEC IdP(s) and temporarily stores them.
c) IDSpace IdP Auth→SP: HTTP Request. The IdP Auth module issues an HTTP request to the SP containing a Liberty-enabled header (or with a Liberty-enabled entry in the User-Agent header).

d) SP→IdP Auth: HTTP Response+Authentication Request. The SP generates a Liberty authentication request and sends it to the IdP Auth module in the body of the HTTP response. The SP could choose to include a list of IdPs it knows about in the request.
e) The IdP Auth compares the received list of IdPs (if present) with the LEC IdP(s) retrieved from the selected cCard. If there is a non-empty intersection, then a cCard-specified IdP is contacted (this shall be the ‘primary’ IdP if possible); if not, then either the protocol terminates or the user could be asked to choose an IdP from amongst those in the SP list. The user could also be offered the choice to store the selected IdP (in the Settings Store) for future authentication attempts. If the SP does not specify a list of IdPs, then the cCard-associated IdP is contacted.
f) IdP Auth→IdP: Authentication Request. The IdP Auth module issues an HTTP POST to submit a SOAP-based Liberty authentication request message to the appropriate IdP. Note that this request must contain the authentication request as received from the SP.

11. Liberty IdP⇄User. If necessary, the IdP authenticates the user. Ideally this process would be mediated by the IDSpace system (using the IdP Auth module), in order to provide a user experience that is consistent across identity management systems. If successful, the IdP generates a SOAP-based, signed Liberty authentication response message and sends it to the IdP Auth module via an SSL/TLS channel.

12. Token Displayer⇄User. If the token is not end-to-end encrypted, the Token Displayer module displays the token and requests user consent to proceed. If consent is granted, the protocol continues; otherwise it terminates.

IDSpace and CardSpace

During or prior to use of IDSpace, the user must create a CardSpace-specific cCard (using the LIP) and/or import a CardSpace-managed InfoCard. The IDSpace generic protocol given in section 4.2, excluding step 12, could then be used to provide the functionality of CardSpace.

Previous Work and Novelty

We have described an architecture for a client-based, platform-independent, protocol-agnostic identity management tool that operates in conjunction with a client web browser. A tool conforming to the architecture provides a user-intuitive means of managing digital identities and credentials for all user web activities.

The Microsoft CardSpace system shares certain features in common with IDSpace. In particular, it too is client-based and operates in conjunction with a web browser.

However, CardSpace requires the identity providers and service providers to implement a specific set of protocols for inter-communication (we refer to these as the ‘CardSpace protocols’, although many of them are based on WS-* standards). Although CardSpace supports a wide range of security token formats, these tokens must be sent using a very specific protocol suite.

This gives rise to a classic ‘chicken and egg problem’: without an established identity infrastructure of IdPs, there is no (or little) incentive for SPs to make the changes necessary to support CardSpace. Similarly, without any customer SPs, there is no (or little) incentive to set up a CardSpace-specific IdP infrastructure.

By contrast, IDSpace enables the technical and other benefits of CardSpace, without requiring SPs and IdPs to make technical modifications to their own systems. That is, IDSpace enables more secure authentication of end users, without any changes to the existing identity infrastructures or service providers. Moreover, once deployed, IDSpace will enable much simpler deployment of more sophisticated technical systems such as the CardSpace protocols (and the many other systems currently emerging).

In addition to these technical benefits, IDSpace gives the convenience and intuitive user experience of CardSpace. The system is also able to offer benefits in terms of transparency of privacy, as the Token Displayer can in some circumstances allow the user to know what details are being requested by the SP.

The Higgins system (which originated as an attempt to provide CardSpace-like functionality on non-Windows platforms) has somewhat similar objectives to IDSpace. This is particularly the case for the active client 2 project (http://wiki.eclipse.org/Active_Client_{—}2.0) where plans have been announced to support OpenID and password management via CardSpace-like selectors. However, it seems that this is to be achieved by requiring SPs and IdPs to support new protocols, and not by adding specific extra functional components to a client device. That is, the technical approach to solving the problem is completely different, and lacks major advantages of the IDSpace system.

Papers describing how to build browser plugins which enable CardSpace/Higgins selectors to support password management without requiring any changes to the selectors and websites have been published. (For example, Haitham S. Al-Sinani and Chris J. Mitchell: Implementing PassCard—a CardSpace-based Password Manager. Technical Report: RHUL-MA-2010-15 (Department of Mathematics, Royal Holloway, University of London), 2010. http://www.ma.rhul.ac.uk/static/techrep/2010/RHUL-MA-2010-15.pdf; Haitham S. Al-Sinani and Chris J. Mitchell. Using CardSpace as a password manager. In, Proceedings of IFIP IDMAN 2010-2^{nd} IFIP WG 11.6 Working Conference on Policies and Research in Identity Management, 2010, Oslo, Norway, volume 343 of IFIP Advances in Information and Communication Technology, pages 18-30. Springer, Boston, 2010)

Operational, open-source prototypes have also been described. (For example http://iescripts.org/view-scripts-808p1.htm and/or http://sourceforge.net/projects/passcard/).

The principal novel benefit offered by the IDSpace architecture, however, is the provision of a client-based system which supports multiple identity management systems in a user-transparent way. That is, it combines the technical benefits, convenience and intuitiveness of the CardSpace user interface with support for multiple systems, without requiring any changes to existing SPs and IdPs.

In order to enable these benefits, which are described in more detail below, the IDSpace architecture incorporates novel components, including the Page Scanner, Activator, Identity System Selector and Token Displayer, which are not found in the CardSpace or Higgins architectures. While much simpler versions of some of these novel components (notably the Page Scanner and Activator) have been described in papers published by the inventors, they have only been described in very specific contexts, and not in the way in which they are used in IDSpace to provide a specific and widely applicable technical benefit.

Benefits of an Embodiment of the Present Invention

An embodiment of the present invention, for example in the context of the IDSpace architecture or an equivalent architecture, is able to provide one or more of the following benefits:

1. As stated previously, enabling the end user to transparently access and use identity and authentication services from different providers, without the necessity for service providers to make technical modifications to their own systems to make this possible. This technical barrier has made the widespread use of such identity and authentication services infeasible. An embodiment of the present invention removes this major technical obstacle.

2. A number of existing authentication/identity management systems leave user open to phishing attacks. This is because these systems (e.g. OpenID, Facebook Connect, Liberty) rely on redirection of the client browser by the Service Provider (SP) to an Identity Provider website. A dishonest SP could redirect the user browser to a ‘fake’ (phishing) Identity Provider, which could then capture and subsequently misuse user credentials. Such an attack can be prevented by the use of an embodiment of the invention, since it is responsible for managing the interaction with the identity provider and it does not rely on browser redirection.

That is, without the present invention detecting phishing would require the user to detect that the browser is communicating with a faked phishing site, which can be very difficult. With an embodiment of the invention, the software running on the client sets up communications with the identity provider, and will automatically detect the presence of a fraudulent site.

3. Users are currently confronted with a multiplicity of different authentication and identity management systems, which operate in a wide variety of different ways with differing user interfaces. This increases the likelihood of user error, with possibly serious security consequences, not least because users often fail to understand precisely what is going on and what they are being asked. This problem is addressed by an embodiment of invention. The IDSpace client enables users to have a consistent way of interacting with a multiplicity of identity management systems, thereby increasing user understanding and reducing the risk of confusion.

4. The vast majority of user authentications involve use of username and password. This is despite the fact that this approach has a host of known vulnerabilities, not least the risk of phishing attacks. Not only does an embodiment of the invention provide a means of managing a multiplicity of authentication/identity management systems, but it can also function as a secure password manager, i.e. as an authentication system itself. This automates the process of username/password authentication, thereby reducing the risk of phishing attacks as well as enabling the use of more secure passwords.

Whilst password management systems are already well known, an embodiment of the invention allows passwords to be managed in the same way as credentials for other identity management systems. It also provides protection against phishing attacks in which users are induced to reveal their passwords to bogus sites.

5. Many current identity management systems involve identity providers passing personal information about a user to a service provider. In some cases users have minimal control over such transfers, which is clearly a threat to user privacy. An embodiment of the invention, through the Token Displayer, allows the user to be informed about all such transfers, thus providing significant privacy benefits.

### SUMMARY OF AN EMBODIMENT OF THE PRESENT INVENTION

A method is proposed herein for use in authenticating an entity to a relying party, to enable the entity to access a protected resource provided by the relying party via a web page, comprising: (a) installing an authentication component in a web browser used by the entity to access the web page, the authentication component being operable, when the entity accesses the web page, to (i) scan the web page (and/or to ask the entity) to identify a plurality of authentication systems supported by the web page, and (ii) to install a user interface component in the web page which is operable to interact with the entity to allow the entity to select which of the plurality of authentication systems to use; and/or (b) using such an installed authentication component.

The or each or at least some of the authentication systems may comprise or make use of or rely upon or be an identity management system.

Following use of the installed interface component to select which of the plurality of authentication systems to use, the selected authentication system may then be used to authenticate the entity to the relying party.

Installing the component in the web browser may comprise associating the component with the web browser, such that the web browser calls the component in use. The web browser is a client-side web browser rather than a browser maintained or provided by the relying party, for example.

Scanning may comprise scanning the web page for mark-up language (e.g. HTML or XHTML) tags that are associated with specific authentication systems.

Installing the user interface component may comprise embedding a descriptive icon (e.g. logo, image, link or button) in the visited web page for each available system. In this case, interacting with the entity may comprise asking the entity to selecting one (e.g. by clicking the selected icon).

Installing the user interface component may comprise embedding forms in the page or by triggering pop-up boxes. In this case, interacting with the entity may comprise asking the user to select the system they wish to use by way of these forms or pop-up boxes

Installing the user interface component may comprise adding an identity management system selection option to an in-page context (right-click) menu. In this case, interacting with the entity may comprise allowing the user to select the system they wish to use from the context menu.

Installing the user interface component may comprise extending the browser frame, e.g. by adding a browser icon, bar or menu. In this case, interacting with the entity may comprise allowing the user to select one of the systems through the extended browser frame.

Installing the user interface component may comprise employing a card selector to display the currently supported identity management systems. In this case, interacting with the entity may comprise allowing the user to select one of the systems using the card selector.

The entity may be a user or a device or a combination of these.

An authentication system is proposed for use in authenticating an entity to a relying party, to enable the entity to access a protected resource provided by the relying party via a web page, comprising an authentication component installable in a web browser used by the entity to access the web page, the authentication component comprising (a) a scanning component which is operable when the entity accesses the web page to scan the web page (and/or to ask the entity) to identify a plurality of authentication systems supported by the web page; and (b) an activation component which is operable when the entity accesses the web page to install a user interface component in the web page which is operable to interact with the entity to enable the entity to select which of the plurality of authentication systems to use.

The scanning component can be considered as being equivalent to the page scanner described elsewhere herein. The activation component can be considered as being equivalent to the activator described elsewhere herein. The user interface component can be considered as being equivalent to the identity system selector described elsewhere herein.

The term web browser is intended to cover any mechanism for accessing web pages.

A program is also proposed for controlling an apparatus to perform a method as herein proposed, or which, when loaded into an apparatus, causes the apparatus to become an apparatus as herein proposed. The program may be carried on a carrier medium. The carrier medium may be a storage medium. The carrier medium may be a transmission medium. An apparatus programmed by such a program is also envisaged, as is a storage medium containing such a program.

An embodiment of the present invention includes the following technical components, working together within an architecture for a client-based identity management tool that operates in conjunction with a client web browser or equivalent service access mechanism:
A page scanner: a module which scans a service provider website login-page in order to discover the identity system(s) supported by the website
An activator, which informs the user that it is possible to use the identity management tool itself, or an external identity provider, to authenticate the user to the service provider and provides the means to enable the user to select a means for doing so
An Identity System Selector, which enables the user to select which identity management system to be used from amongst those supported by the service provider website

A component may be provided which enables the user to learn which personal information is being revealed, and which gives the user direct control over such disclosures

The combination of these features within the architecture allows the technical effects and benefits previously described.

It will be appreciated that operation of one or more of the above-described components can be provided in the form of one or more processors or processing units, which processing unit or units could be controlled or provided at least in part by a program operating on the device or apparatus. The function of several depicted components may in fact be performed by a single component. A single processor or processing unit may be arranged to perform the function of multiple components. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

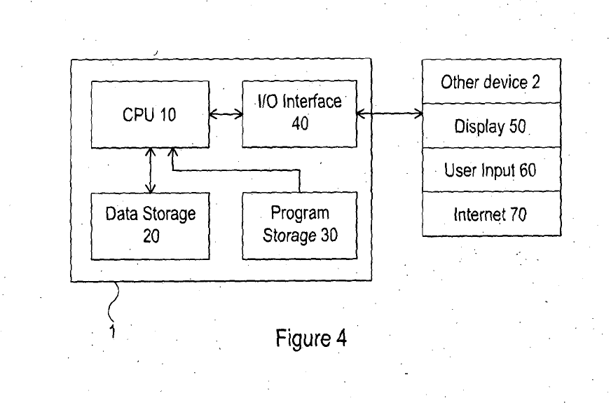

FIG. 4 is a schematic illustration of a device 1 for use in implementing an embodiment of the present invention. A computer program for controlling the device 1 to carry out a method embodying the present invention is stored in a program storage 30. Data used during the performance of a method embodying the present invention is stored in a data storage 20. During performance of a method embodying the present invention, program steps are fetched from the program storage 30 and executed by a Central Processing Unit (CPU) 10, retrieving data as required from the data storage 20. Information can be stored back in the data storage 20, or sent to an Input/Output (I/O) interface 40, which may comprise a transmitter for transmitting data to other devices 2, or to a display 50, as required. Likewise, the Input/Output (I/O) interface 40 may comprise a receiver for receiving data directly from other devices 2 or from a user input device 60 (e.g. keyboard or mouse), for example for use by the CPU 10. The Input/Output (I/O) interface 40 may also connect the device 1 to the Internet.

It will be appreciated by the person of skill in the art that various modifications may be made to the above described examples without departing from the scope of the present invention.

1.-26. (canceled)

27. A method for use in authenticating an entity to a relying party, to enable the entity to access a protected resource provided by the relying party via a web page, comprising: (a) installing an authentication component in a web browser used by the entity to access the web page, the authentication component being operable, when the entity accesses the web page, to (i) scan the web page to identify a plurality of authentication systems supported by the web page, and (ii) to install a user interface component in the web page which is operable to interact with the entity to allow the entity to select which of the plurality of authentication systems to use; and/or (b) using such an installed authentication component.

28. A method as claimed in claim 27, wherein the or each or at least some of the authentication systems comprise or make use of or rely upon an identity management system.

29. A method as claimed in claim 27, wherein, following use of the installed interface component to select which of the plurality of authentication systems to use, the selected authentication system is used to authenticate the entity to the relying party.

30. A method as claimed in claim 27, wherein installing the component in the web browser comprises associating the component with the web browser, such that the web browser calls the component in use.

31. A method as claimed in claim 27, wherein scanning comprises scanning the web page for mark-up language, for example HTML or XHTML tags, that are associated with specific authentication systems.

32. A method as claimed in claim 27, wherein installing the user interface component comprises embedding a descriptive icon, for example a logo, image, link or button, in the visited web page for each available system.

33. A method as claimed in any claim 32, wherein interacting with the entity comprises asking the entity to select one of the icons, for example by clicking the selected icon.

34. A method as claimed in claim 27, wherein installing the user interface component comprises embedding forms in the page or triggering pop-up boxes.

35. A method as claimed in claim 34, wherein interacting with the entity comprises asking the user to select the system they wish to use by way of the forms or pop-up boxes.

36. A method as claimed in claim 27, wherein installing the user interface component comprises adding an identity management system selection option to an in-page context or right-click menu.

37. A method as claimed in claim 36, wherein interacting with the entity comprises allowing the user to select the system they wish to use from the context or right-click menu.

38. A method as claimed in claim 37, wherein installing the user interface component comprises extending the browser frame, e.g. by adding a browser icon, bar or menu.

39. A method as claimed in claim 38, wherein interacting with the entity comprises allowing the user to select one of the systems through the extended browser frame.

40. A method as claimed in claim 27, wherein installing the user interface component may comprise employing a card selector to display the currently supported identity management systems.

41. A method as claimed in claim 40, wherein interacting with the entity comprises allowing the user to select one of the systems using the card selector.

42. A method as claimed in claim 27, wherein scanning comprises asking the entity to identify the plurality of authentication systems supported by the web page.

43. A method as claimed in claim 27, wherein the entity is a user or a device or a combination of these.

44. An authentication system for use in authenticating an entity to a relying party, to enable the entity to access a protected resource provided by the relying party via a web page, comprising an authentication component installable in a web browser used by the entity to access the web page, the authentication component comprising (a) a scanning component which is operable when the entity accesses the web page to scan the web page to identify a plurality of authentication systems supported by the web page; and (b) an activation component which is operable when the entity accesses the web page to install a user interface component in the web page which is operable to interact with the entity to enable the entity to select which of the plurality of authentication systems to use.

45. A non-transitory computer-readable storage medium storing a program for controlling a processor to perform a method as defined in claim 27.
